(19) United States
(12) Patent Application Publication
(10) Pub. No.: US 2010/0171361 A1
(43) Pub. Date: Jul. 8, 2010

(54) Tyre Valve

(75) Inventors: Jérôme Monjuvent, Ennezat (FR); Patrick Botte, Cebazat (FR); Julie Moynet, Clermont-Ferrand (FR); Matteo Gosi, Gremona (IT)

Correspondence Address: BUCHANAN, INGERSOLL & ROONEY PC, POST OFFICE BOX 1404, ALEXANDRIA, VA, 22313-1404, US

(73) Assignees: Michelin Recherche Et Technique S.A., Granges-Paccot (CH); Wonder S.p.a., Cremona (IT); TRW Automotice U.S., LLC, Livonia, MI (US)

(21) Appl. No.: 12/309,269

(22) PCT Filed: Jul. 9, 2007
(86) PCT No.: PCT/EP2007/056981

§ 371 Date: Oct. 7, 2009

Related U.S. Application Data
(60) Provisional application No. 60/839,691, filed on Aug. 24, 2006.

(30) Foreign Application Priority Data
Jul. 13, 2006 (FR) 0606427

(51) Int. Cl. B60C 29/02

(52) U.S. Cl. 301/5.24

(57) ABSTRACT

Inflation valve (330; 430) configured for use in a tyre (10)—wheel (20)—assembly, the wheel comprising a mounting rim for the tyre provided with a valve hole of diameter DT, the valve comprising: (i) a deformable valve base (335; 435) designed to fix the valve in the said valve hole in a leakproof manner, the valve base being provided with a peripheral groove (36) of diameter DR, DR being larger than DT, and of width E, designed to fit over the edge (21) of the valve hole; (ii) a rigid, rectilinear tube (33) of circular cross-section, a first end of which is configured to remain outside the tyre and a second end of which is provided with means to enable connection with a unit (40) configured to be fitted inside the tyre, the tube passing through the valve base and extending on either side of the valve base, the inflation valve comprising in the part thereof located between a first plane (71) which is perpendicular to the axis of the tube and intersects the said peripheral groove half-way along, and a second plane (72) perpendicular to the tube's axis and containing the point(s) of the valve base closest to the said second end of the tube, an annular hollow space (83;84) which separates the tube from the valve base and the volume of which is greater than or equal to

$$\frac{( {DR}^{2} - {DT}^{2} ) \cdot E}{8} .$$

### FIELD OF THE INVENTION

The present invention concerns tyre inflation valves of the “snap-in” type and more particularly “snap-in” valves designed to be combined with electronic systems that enable certain tyre utilisation parameters to be measured and/or transmitted.

### TECHNOLOGICAL BACKGROUND

In the last few years there has been a rapid development of “smart” tyres, i.e. tyres fitted with electronic systems that enable the measurement of certain parameters such as inflation pressure, tyre temperature or external forces exerted on the tyre during rolling. These tyres are generally also provided with electronic systems that enable the measurements so obtained to be transmitted to the vehicle on which the tyres are mounted. For the sake of brevity the measurement and/or transmission systems will be referred to indiscriminately as “electronic systems” in what follows.

Such electronic systems are very often located inside the tyre. They can be fixed directly on the tyre itself, for example in a pocket formed on an inside wall of the tyre; patent application US 2005/021777 describes an example of such a solution. Another way of fixing an electronic system, in a tyre is to use a “patch” glued to an inside wall of the tyre (see for example the U.S. Pat. No. 6,782,741). A third possible approach is to attach the electronic system to the inflation valve of the tyre: U.S. Pat. No. 6,278,361 describes a design in which sensors are arranged in a casing attached to the valve. The present invention relates to this third approach.

Nowadays several valve types are available, which are designed for very different uses. In the field of passenger cars, valves are known in particular which are fixed to the wheel rim by screwing (“clamp-in” valves): the valve body is introduced into the valve hole on the side of the rim corresponding to the inside of the tyre volume when the tyre has been mounted and is locked by a nut screwed on from the other side of the rim. The valve base has an annular groove to hold an annular sealing joint.

Another type of valve, which is fixed by clipping into place, is known by the name “snap-in” valve. In such valves the tube (which is usually made of metal) that contains the actual valve mechanism is anchored in a valve body, which may be made of rubber. The valve body has a peripheral groove which fits around the edge of the valve hole. The invention concerns valves of this type; an example is shown in FIG. 4. An example of a “snap-in” valve comprising an electronic system is described in the U.S. Pat. No. 6,005,480.

A simple way to attach the “snap-in” valve to an electronic system configured for fitting inside the tyre is to extend the valve tube and fix the electronic system mechanically on the end of the valve that is to be inside the tyre.

However, extending the valve tube can have undesirable effects, in particular making the valve less easy to fit and less airtight.

### DESCRIPTION OF THE INVENTION

The purpose of the present invention is to improve the ease with which an inflation valve designed to be attached to an electronic system can be mounted, and to ensure that it is leak proof. In what follows, the electronic system and its casing (if any) will be called the “unit configured for fitting inside the tyre”, or more simply, the “unit”.

This objective is achieved by an inflation valve designed to be used on a tyre-wheel assembly, the wheel of this assembly comprising a mounting rim for the tyre provided with a valve hole of diameter DT, the valve comprising:
a deformable valve base designed to fix the valve in the said valve hole in a leakproof manner, the valve base being provided with a peripheral groove of diameter DR larger than DT and of width E, provided in order to fit over the edge of the valve hole;
a rigid, straight tube of circular cross-section, a first end of which is configured to remain outside the tyre and a second end of which is provided with means to enable connection with a unit configured for fitting inside the tyre, the said tube passing through the valve base;
   wherein, in the part of the valve located between a first plane perpendicular to the axis of the tube and which intersects the said peripheral groove half-way along, and a second plane perpendicular to the tube's axis and containing the point(s) of the valve base closest to the said second end of the tube, there is an annular hollow space which separates the tube from the valve base and which has a volume that is greater than or equal to:

$$\frac{( {DR}^{2} - {DT}^{2} ) \cdot π \cdot E}{8} ,$$

and wherein the tube intersects the said second plane.

This geometry is particularly suitable for enabling the material constituting the valve base to be positioned properly when the valve is mounted on the rim, which facilitates mounting and improves air tightness. In addition, such a geometry improves the airtightness ensured by the valve even when the tube tilts within the valve hole, as can happen if the wheel is severely stressed.

The person of ordinary skill in the art will understand that the volume of the said hollow space separating the tube from the valve base cannot be unlimited. Too large a hollow space would adversely affect the stability of the base and consequently the airtightness between the valve base and the valve hole. Preferably, the said annular hollow space separating the tube from the valve base is smaller or equal to

$$\frac{( {DR}^{2} - {DT}^{2} ) \cdot π \cdot E}{2} ,$$

an more
preferably still, smaller than or equal to

$$\frac{( {DR}^{2} - {DT}^{2} ) \cdot π \cdot E}{4} .$$

In a preferred embodiment the geometry of the valve base is chosen such that there is an angle alpha (α) greater than or equal to 15° and smaller than or equal to 25° (and preferably smaller than 20°), such that a cone:
the axis of which coincides with the axis of the tube;
which opens towards the second end of the tube with an apex angle equal to alpha (α); and
the apex of which is located on a third plane perpendicular to the axis of the tube and is positioned between the said first tube end and the said first plane, at the same distance from the said first plane as the said second plane,
   has no intersection with the valve base.

### BRIEF DESCRIPTION OF THE DRAWINGS

The invention will be better understood thanks to the description of the drawings, in which:

FIG. 1 shows a schematic perspective view of a wheel of the prior art, provided with a unit designed to be fitted inside the tyre attached to the inflation valve;

FIG. 2 shows a schematic sectioned view of a tyre-wheel assembly of the prior art, provided with a unit designed to be fitted inside the tyre attached to the inflation valve;

FIG. 3 shows a schematic perspective view of an inflation valve and a casing attached to the valve, designed to accommodate sensors;

FIGS. 4 to 7 show schematic sectioned views of “snap-in” valves which are not mounted on a tyre-wheel assembly;

FIGS. 8 to 11 show schematic representations of “snap-in” valves before and after their mounting on a tyre-wheel assembly.

### DETAILED DESCRIPTION OF THE INVENTION

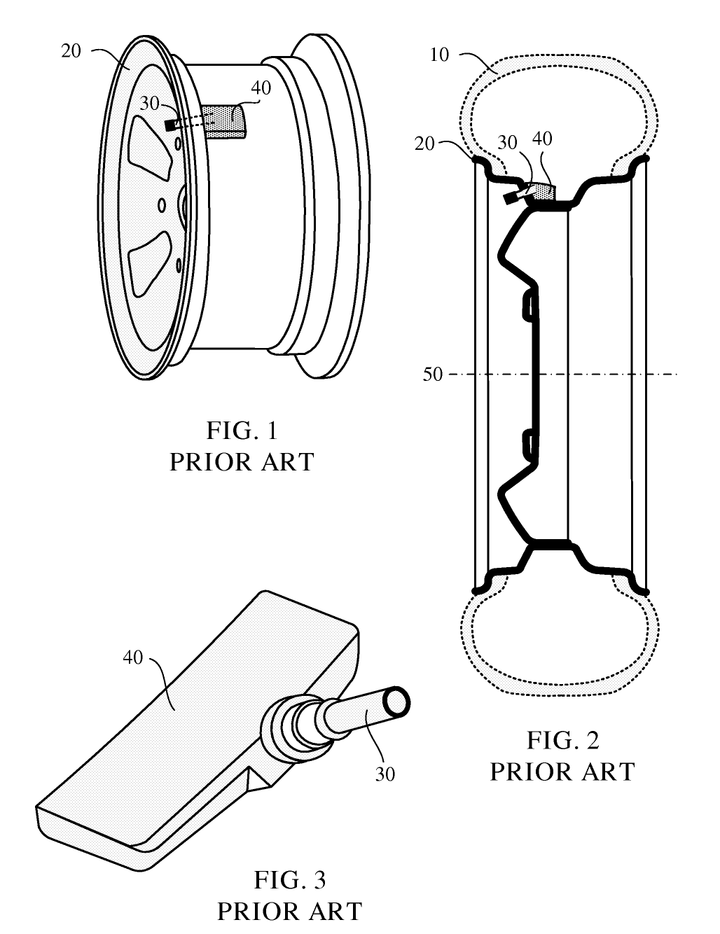

FIG. 1 shows a perspective view of a wheel 20 of the prior art, fitted with an inflation valve 30 and a casing 40 provided in order to accommodate sensors. For the sake of clarity the tyre 10 is not shown.

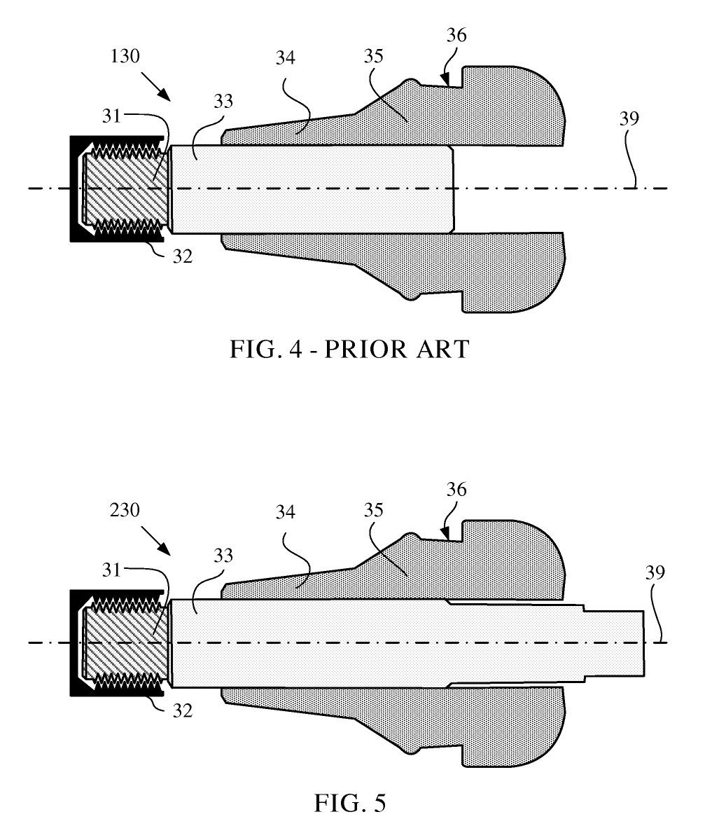

FIG. 2 shows a sectioned view of another tyre-wheel assembly of the prior art, comprising a tyre 10 and a wheel 20 and fitted with an inflation valve 30 and a casing 40 provided to accommodate sensors. The rotation axis 50 of the tyre-wheel assembly is also shown.

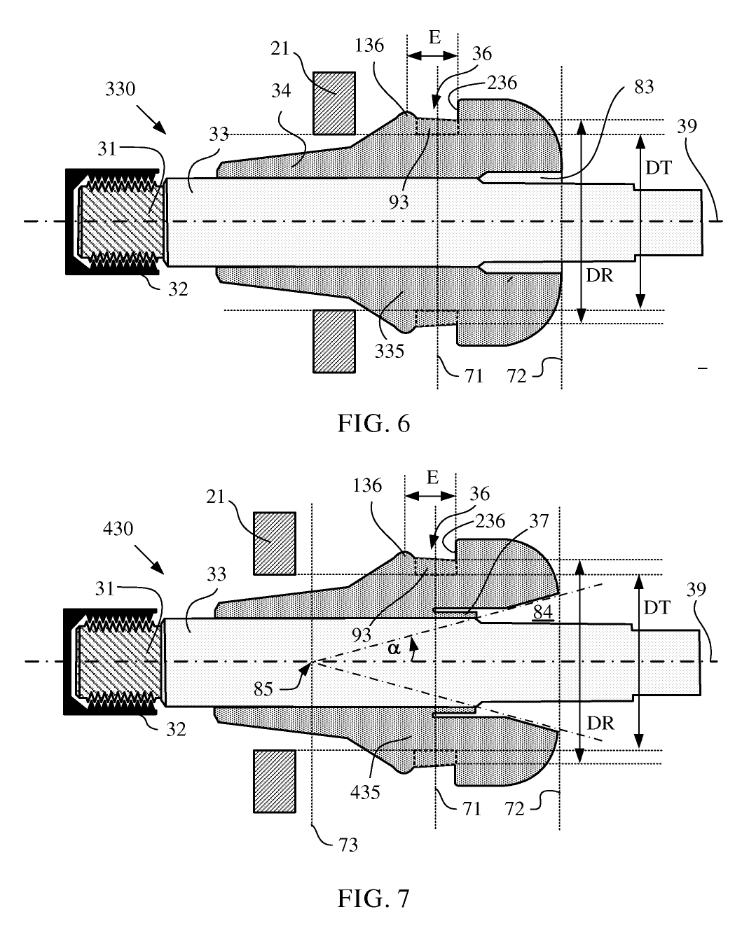

FIG. 3 shows a schematic perspective view of an inflation valve 30 and a casing 40 attached to the valve and designed to accommodate sensors; such a casing is known for example from U.S. Pat. No. 6,278,361.

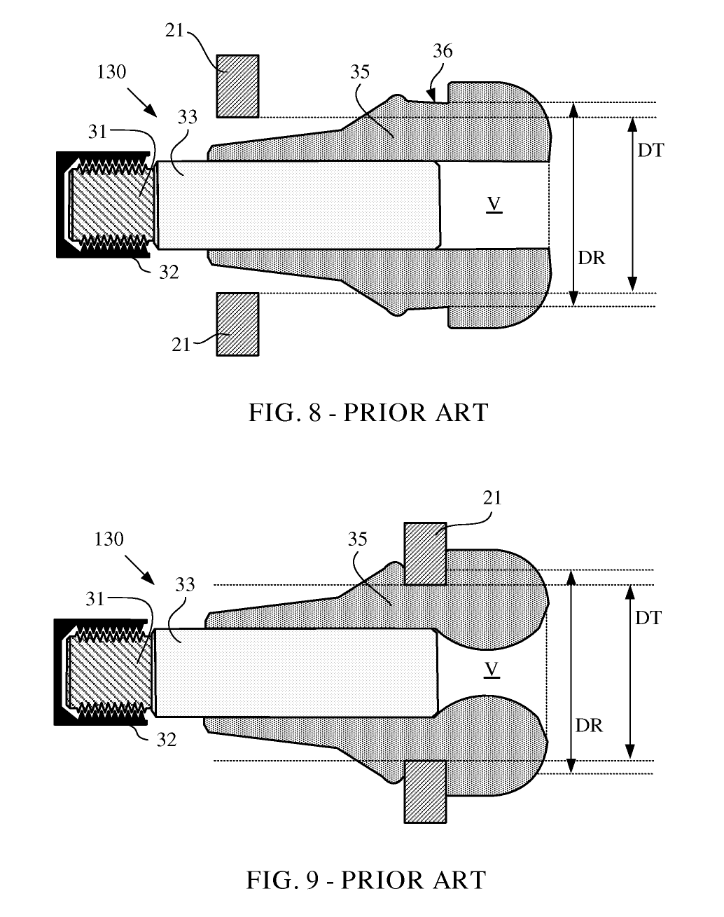

FIG. 4 shows a schematic sectioned view of a “snap-in” valve 130 according to the prior art. It comprises:
a threaded valve mouth onto which is screwed a cap 32 the purpose of which is to protect the valve at times other than during inflation or deflation;
a metallic tube 33 inside which is the actual valve mechanism (not shown);
a sheath 34, for example made of rubber, designed to protect the tube 33;
a valve base 35 comprising a peripheral groove 36 (sometimes also called the “sealing diameter”) provided in order to fit round the edge of the valve hole.
   The axis 39 of the tube 33 is also shown.

One end of the tube 33 is located at the level of the peripheral groove 36, which facilitates removal because it is thus possible, without interference by the tube 33, to cut off the part of the valve base 35 located inside the tyre-wheel assembly, for example using a knife blade, and to extract the other part easily from the valve hole.

When a unit configured for fitting inside the tyre has to be attached to the valve, it can be advantageous to extend the tube 33 so that the unit can be fixed to the end of the tube. Such a valve 230 is shown in FIG. 5.

It has been found that valves such as the one shown in FIG. 5 are more difficult to mount and that their airtightness is less good compared with valves of the prior art, such as the valve of FIG. 5.

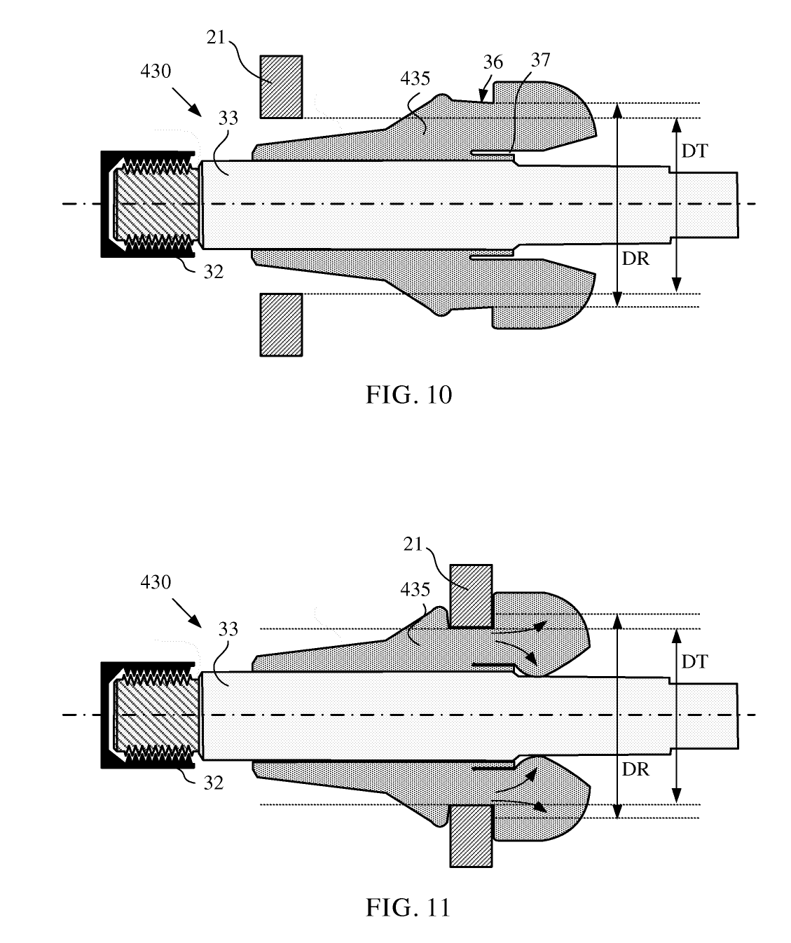

FIGS. 8 and 9 illustrate this situation. FIG. 8 shows a section through a valve 130 of the prior art before it is mounted in a valve hole of a tyre-wheel assembly the edge 21 of which can be seen. The diameter DT of the valve hole is also shown; in this case it is 11.5 mm.

During the mounting of the valve 130, the valve 130 is pushed into the valve hole so that the groove 36, the diameter DR of which is in this case 15 mm, fits over the edge 21 of the valve hole. Since the material of the base of the valve 130 is virtually incompressible, the local compression of the base of the valve 130 gives rise to a displacement of material.

The result is shown schematically in FIG. 9. It can be seen that a certain amount of material has moved into the hollow space V which extends the tube 33.

Now, when the tube 33 passes right through the valve base 35 and extends beyond the valve base 35, as is the case for the valve 230 (FIG. 5), this movement of material is no longer possible because the volume V is occupied by the extension of the tube 33. This makes fitting more difficult and produces stresses on the valve base 35, which can adversely affect the airtightness between the valve base 35 and the valve hole in which it is inserted.

This difficulty is overcome with the help of “snap-in” valves according to the invention, such as those illustrated schematically in cross-section by FIGS. 6 and 7.

In contrast to the valves described earlier, those valves have a special valve base geometry.

The valve 330 in FIG. 6 has a deformable valve base 335 and a tube 33. It is designed to be mounted in a valve hole with a depth between 1.8 and 4 mm, which implies a value E close to 4 mm. The figure also shows the position of a first plane 71 which is perpendicular to the axis 39 of the tube 33 and intersects the peripheral groove 36 (of diameter DR) half-way along, i.e. an equal distance between the two edges of the groove 36, and the position of a second plane 72 which is also perpendicular to the axis 39 of the tube 33 and which contains the points of the valve base that are closest to the end of the tube configured to be inside the tyre. As in the valve 230 of FIG. 5, the tube 33 intersects this second plane, but in contrast to the valve 230 of FIG. 5, this valve comprises, between the first plane 71 and the second plane 72, an annular hollow space 83 which separates the tube 33 from the valve base and the volume of which is greater than or equal to half the annular volume 93 which has to be displaced when the valve 330 is inserted into the valve hole (diameter DT) the edge 21 of which is shown. This volume 93 is essentially equal to:

$$\frac{( {DR}^{2} - {DT}^{2} ) \cdot π \cdot E}{4} ,$$

where E is the width of the peripheral groove 36, in this case 4 mm. E corresponds to the distance separating the centre of the collar 136 and the wall 236 that forms the “sealing lip”. It has been found that when the volume of the annular hollow space 83 is equal to or greater than half the annular volume 93, it is significantly easier to fit the valve and its airtightness is improved.

FIG. 7 shows a preferred embodiment of the invention. For the valve 430 there is an angle alpha (here, α=17°) such that a cone:
the axis of which coincides with the axis 39 of the tube 33;
which opens towards the end of the tube 33 which is configured to be inside the tyre, with an apex angle equal to alpha; and
the apex 85 of which is located substantially on a third plane 73 which is perpendicular to the axis 39 of the tube and which intersects the tube between the end of the tube opening into the valve mouth 31 and the first plane 71, the distance between the first plane 71 and the third plane 73 being the same as the distance between the first plane 71 and the second plane 72;
   does not intersect with the valve base 435.

It should be noted that to say that the cone does not intersect the valve base 435 does not exclude an intersection with the tongue 37 that may be formed in the valve base 435. This tongue 37 sticks to the tube 33 and does not undergo any movement relative to the tube 33 when the valve is mounted in the valve hole. What is important is that there must be no intersection between the cone and the part of the base which is located between the planes 71 and 72 and is displaced during mounting.

Of course, the valve 430 also fulfils the criterion mentioned earlier, namely that the volume of the annular hollow space 84 is greater than half the annular volume 93. In this case the volume of the hollow space 84 is equal to two-thirds of the volume 93.

FIGS. 10 and 11 illustrate this state of affairs. FIG. 10 shows the valve 430 before mounting in a valve hole; the figure is essentially the same as FIG. 7.

During the mounting of the valve 430, the valve 430 is pushed into the valve hole so that the groove 36 fits over the edge 21 of the valve hole. Since the material of the valve base 435 is virtually incompressible, the local compression of the valve base 435 gives rise to a displacement of material the result of which is shown schematically in FIG. 11. It can be seen that a certain amount of material is displaced so as to fill the hollow space (84, see FIG. 7) between the valve base 435 and the tube 33 and come into contact, locally, with the tube 33. The movement of material is suggested by arrows. The particular geometry of the valve base 435 facilitates part of these movements (the part that amounts to a rotation of material about an axis perpendicular to the plane of the section), and this facilitates mounting.

The geometry of valves according to the invention also has the effect of improving their pressure resistance. Whereas the valves currently in common use are designed to resist a pressure of 13 bar (or 3 times the maximum nominal pressure when cold of 4.5 bars), the valves according to the invention show no leakage at a pressure of 19 bar.

1. An inflation valve configured for use in a tyre-wheel-assembly, the wheel comprising a mounting rim for the tyre provided with a valve hole of diameter DT, the valve comprising:
a deformable valve base designed to fix the valve in the said valve hole in a leakproof manner, the valve base being provided with a peripheral groove (36) of diameter DR, DR being larger than DT, and of width E, designed to fit over the edge (21) of the valve hole;
a rigid, rectilinear tube of circular cross-section, a first end of which is configured to remain outside the tyre and a second end of which is provided with means to enable connection with a unit configured to be fitted inside the tyre, the tube passing through the valve base;
wherein, in the part of the valve located between a first plane perpendicular to the axis of the tube and which intersects the said peripheral groove half-way along, and a second plane perpendicular to the axis of the tube and which contains the point(s) of the valve base closest to the said second end of the tube, there is an annular hollow space which separates the tube from the valve base and the volume of which is greater than or equal to:
$$\frac{( {DR}^{2} - {DT}^{2} ) \cdot π \cdot E}{8} ,$$
and wherein the tube intersects the said second plane (72).

2. The inflation valve of claim 1, wherein the volume of the said annular hollow space separating the tube from the valve base is smaller than or equal to:
$$\frac{( {DR}^{2} - {DT}^{2} ) \cdot π \cdot E}{2} .$$

3. The inflation valve of claim 2, wherein the volume of the said annular hollow space separating the tube from the valve base is smaller than or equal to:
$$\frac{( {DR}^{2} - {DT}^{2} ) \cdot π \cdot E}{4} .$$

4. The inflation valve of claim 1, wherein there is an angle alpha (α) greater than or equal to 15° and smaller than or equal to 25°, such that a cone:
the axis of which coincides with the axis of the tube; which opens towards the second end of the tube, with an apex angle equal to alpha (α); and
the apex of which is located on a third plane perpendicular to the axis of the tube and which intersects the tube between the said first end of the tube and the said first plane, the distance between the first plane and the third plane being the same as the distance between the first plane and the second plane does not intersect the valve base.

5. The inflation valve of claim 4, wherein the angle alpha (α) is smaller than or equal to 20°.
